(19) United States
(12) Patent Application Publication
(10) Pub. No.: US 2016/0063615 A1
(43) Pub. Date: Mar. 3, 2016

(54) Marketing Products in Dynamic Content

(71) Applicant: ICON Health & Fitness, Inc., Logan, UT (US)

(72) Inventor: Eric C. Watterson, Logan, UT (US)

(21) Appl. No.: 14/836,487

(22) Filed: Aug. 26, 2015

Related U.S. Application Data
(60) Provisional application No. 62/042,674, filed on Aug. 27, 2014.

(51) Int. Cl. G06Q 30/06

(52) U.S. Cl. CPC G06Q 30/0643

(57) ABSTRACT

Marketing products includes implementing a purchase interface to be displayed with the dynamic content in a display screen of the display device, the purchase interface including a region associated with a product presented in the dynamic content; determining whether the region is selected; and initiating a task associated with purchasing the product based at least in part on the determining.

### RELATED APPLICATIONS

This application claims priority to U.S. Patent Application Ser. No. 62/042,674 titled “Marketing Products in Dynamic Content” and filed on 27 Aug. 2014, which application is herein incorporated by reference for all that it discloses.

### BACKGROUND

Often viewers of television programs view products in their programs that they desire to purchase. In response to viewing these products in the program and desiring to purchase them, the viewer often searches for the product on the internet or at a brick and mortar store. In some situations, the viewer has a high level of confidence that the version of the product in the program meets his or her needs while at the same time having a lower confidence that different versions of the products or similar products of different brands meet those same needs. Many times, the viewer is unable to find the exact product from the program online or at the brick and mortar store, which may cause the viewer some level of discomfort that the found product is not the same as the product viewed in the program.

One type of system to assist users in finding the same products as seen on television is disclosed in U.S. Pat. No. 7,899,705 issued to Richard C. Fuisz. In this reference, a system is described whereby the visual image on a film or television program is utilized to market that specific product. In such a system, film\television is combined with computer technology to provide real-time or delayed access to product data. Viewers identify a product or object displayed in a video, television show or movie and by merely pointing and clicking on the object to obtain marketing and other data.

### SUMMARY

In one embodiment, a method for marketing products includes implementing a purchase interface to be displayed with dynamic content in a display screen of a display device, the purchase interface includes a first region associated with a product presented in the dynamic content and a second region of the display screen dedicated to displaying the dynamic content. The first region is a transparent dynamic area that corresponds to where the product is displayed in the display screen.

The method may include determining whether the first region is selected.

The method may include initiating a task associated with purchasing the product based at least in part on the determining.

The dynamic content may depict a real time event.

The dynamic content may be a scheduled program broadcasted over a distribution network.

The purchase interface may include a menu identifying the product.

The first region may be a transparent dynamic area that corresponds to where the product is displayed in the display screen.

Initiating a task associated with purchasing the product may include sending a product website that provides a mechanism for purchasing the product.

Initiating a task associated with purchasing the product may include completing an order of the product.

Initiating a task associated with purchasing the product may include populating user information into a digital form for purchasing the product.

Sending dynamic content to a display screen may include streaming the dynamic content to the display screen.

The product may include at least one of an article of clothing visually depicted in the dynamic content, an apparatus visually depicted in the dynamic content, or combinations thereof.

The first region may move around within the display screen with the movement of the product.

The product may include an audio component of the dynamic content presented with a visual component of the dynamic content.

The product may include a map of a route displayed in the dynamic content.

The method may include identifying one or more products of interest presented in the dynamic content based at least in part on an area of the display device being viewed

Identifying one or more products of interest may include capturing, with a camera, an image of a user viewing the display screen.

The method may include depicting the one or more products of interest in a menu presented in the display screen.

The method may include displaying a visual representation of the product in the purchase interface.

In one embodiment, a system for marketing products includes a content module to send dynamic content to a display device; an interface module to send a purchase interface to be displayed with the dynamic content in a display screen of the display device, the purchase interface including a region associated with a product presented in the dynamic content; an input module to determine whether the region is selected; a purchase module to initiate a task associated with purchasing the product in response to the determining; an interest module to identify one or more products of interest presented in the dynamic content based at least in part on an area of the display device being viewed; and a menu module to depict products of interest in a menu presented in the display screen.

The product may include at least one of an article of clothing visually depicted in the dynamic content, an apparatus visually depicted in the dynamic content, or combinations thereof.

The product may include an audio component of the dynamic content presented with a visual component of the dynamic content.

In one embodiment, a display device includes a display screen to depict dynamic content, a processor and memory. The memory includes programmed instructions to cause the processor to present a purchase interface with the dynamic content in the display screen, the purchase interface including a region associated with a product presented in the dynamic content; determine whether the region is selected; and initiate a task associated with purchasing the product in response to the determining.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of a system for marketing products in accordance with the present disclosure.

FIG. 2 illustrates a perspective view of an example of a display device in accordance with the present disclosure.

FIG. 3 illustrates a perspective view of an example of a display device in accordance with the present disclosure.

FIG. 4 illustrates a block diagram of an example of a marketing system in accordance with the present disclosure.

FIG. 5 illustrates a block diagram of an example of the interface module in FIG. 4.

FIG. 6 illustrates a block diagram of an example of the purchase module in FIG. 4.

FIG. 7 illustrates a block diagram of an example of the interest module in FIG. 4.

FIG. 8 illustrates a block diagram of an example of a method for marketing products in accordance with the present disclosure.

FIG. 9 illustrates a block diagram of an example of a method for marketing products in accordance with the present disclosure.

FIG. 10 illustrates a block diagram of an example of a system for marketing products in accordance with the present disclosure.

Throughout the drawings, identical reference numbers designate similar, but not necessarily identical, elements.

### DETAILED DESCRIPTION

For purposes of this disclosure, the term “product” may refer to tangible goods, audio recordings, software products, services, other types of products that can be purchased, or combinations thereof. Further, for purposes of this disclosure, the term “dynamic content” may refer to content that changes frequently. This “dynamic content” may include at least a video component.

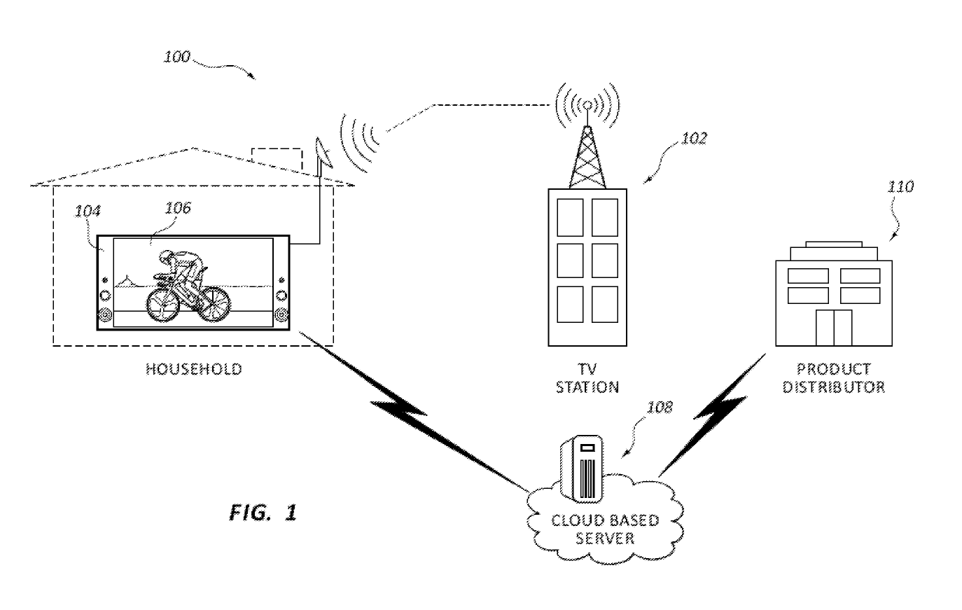

Particularly, with reference to the figures, FIG. 1 depicts a system 100 for marketing products in accordance with the present disclosure. In this example, a television station 102 is broadcasting dynamic content to a display device 104, such as a television, a personal computer, or another type of display device. The display device 104 includes a display screen 106 capable of displaying the dynamic content from the television station. Further, the display device 104 is in communication with a cloud device 108, and the cloud device 108 is in communication with a product distributor 110.

The television station 102 may be in communication with the display device 104 through any appropriate delivery mechanism. For example, the television station may stream live data of an event as the dynamic content to the display device. These deliver mechanisms may be accomplished over a telecommunications network, radio network, a television network, a local area network, a wide area network, the internet, another type of network, or combinations thereof. Further, any appropriate type of communication protocol may be used. For example, the dynamic content may be sent through a HTTP Live Streaming protocol, Wi-Fi, Bluetooth, media streaming communications protocol, adaptive bitrate streaming, other types of protocols, or combinations thereof. The dynamic content may be movies, scheduled programs, televised programs, live events, commercials, other types of dynamic content, or combinations thereof.

While this example is described with reference to a television station being the source of the dynamic content, any appropriate dynamic content source may be used in accordance with the principles described herein. For example, the dynamic content may be delivered from a movie repository, a sitcom repository, a repository of education programs, or other types of dynamic content accessible over the internet or another type of network. For example, the dynamic content may be accessible through social media sites, libraries of downloadable online videos clips, other locations, or combinations thereof. In some cases, dynamic content depicts a live event, such a golfing tournament, a cycling competition, a fashion show, a press release, another type of live event, or combinations thereof. In other examples, the dynamic content is a pre-recorded program capable of being broadcast at a scheduled time or accessible over the internet or another type of network on demand.

Any appropriate type of display device 104 may be used. For example, the display device 104 may include a smart phone, an electronic tablet, a mobile device, a laptop, a desktop, a television, a flat screen, a plasma television, a touch screen, a projector, another type of television, another type of display device, or combinations thereof.

The dynamic content may include multiple components. For example, the dynamic content may include a video component that includes, for example, a motion picture. Further, the dynamic content may include an audio component. Such an audio component may include the sound recordings associated with the dynamic content such as the voices of the characters in a program. In some examples, the audio component may include music played during this program. Further, the dynamic content may include other types of components.

The dynamic content may be presented to the user through the display device 104. The video component may be presented through the display screen 106, while the audio component may be presented to the user through speakers incorporated into or in communication with the display device 104.

In the illustrated example, the dynamic content includes footage of a real time event being streamed to the display device 104 of a cycling race. Footage of a cyclist is being displayed in the dynamic content. The articles of clothing being worn by the cyclist are viewable in the display screen, as well as the cyclist's bicycle and other cycling accessories. The display device 104 may present a purchase interfere for these products in the display screen to allow the user to purchase the items seen during the live event. For example, a cycling enthusiast may desire to use the highest quality cycling accessories available and may believe that the professional athletes in the live cycling race use the highest quality. In this example, the cycling enthusiast may use the purchase interface to purchase at least one cycling accessory which is being used by one of the professional athletes and is displayed in the dynamic content.

For example, products displayed in the dynamic content being used by the cyclists may be identified and presented in a menu of the dynamic interface. The products may be identified by items located in a repository that are collected before or during the live event. In one scenario, the supplier of cycling helmets may notify the source of the dynamic content that certain riders in the cycling race will be wearing their helmets. When this rider is presented in the dynamic content, the helmet is displayed in a menu where the viewer has the option of purchasing the helmet. The dynamic content supplier may have information about the helmet, such as the manufacturer and the product number. In response to the user identifying a desire to purchase the helmet, the display device 104 may send a purchase request to the supplier.

In other examples, the dynamic content provider may request that the competitors in the cycling race identify the products that they will be using in the race. This information may be supplied to a repository, and metadata may be associated with the cyclists so that as they are displayed in the dynamic content, the products associated with the user is made available to viewers through the purchase interface for purchasing.

In yet another example, digital analytics may identify the products by comparing the products to available online images over the network, catalogues, commercials, other sources, or combinations thereof. In yet other examples, employees of the television station or other type of dynamic content source may manual determine the types of products being used in the race. In response to determining the types of products being used in the race, the purchase interface may make the identified products available for purchasing.

While this example has been described with reference to a live cycling race, the principles described above may be applied to other types of dynamic content. For example, the products used in a movie may be identified during or before a movie is displayed. The products in this movie may include the clothing worn by actresses, the sports cars driven by the actors, the watches and jewelry worn by the actors, the sporting equipment used by the actors, other types of products used by the actors, other types of products displayed in the dynamic content, or combinations thereof. In the case of pre-recorded dynamic content, the purchase interface may be preprogrammed to make certain products available for purchase at specific times during the movie or other type of dynamic content.

In some examples, the music playlists, ringtones, or other types of audio sounds presented in the dynamic content may also be available for purchase. For example, an actor's phone in the movie may be programmed with a unique ringtone. As or after that ringtone is presented in the dynamic content, the purchase interface may display an icon representing the ringtone indicating that this a ringtone is available for purchase. In the case with the playlist of songs presented in the dynamic content, the purchase interface may make the entire playlist available for a fixed price. In other examples, the purchase interface may provide the user an option to purchase a subset of the songs selected by the user.

In the example where the dynamic content includes a live racing event, a map of the racing event may be one of the products available for purchase through the purchasing interface. This map may be a tangible map that can be delivered to the viewer's home. In other examples, the map may be part of a program that the user can download onto an exercise machine, such as a treadmill or a stationary bike. The exercise machine can use data from the map to simulate the race course. In this situation, a viewer of the live racing event may decide to virtually compete with the racers during or after the race is over. The map may cause the treadmill to change an incline angle, a resistance, a side-to-side tilt angle, another parameter of the exercise machine, or combinations thereof to simulate the course according to the map.

In other examples, additional types of products may be made available for purchase through the purchase interface. Examples of \ other types of products may include airline reservations or completing travel arrangement to take the viewer to a location depicted in the dynamic content. For example, if the characters of a television sitcom take a vacation to a tropical resort, the purchase interface may make available travel packages to that resort or other hotels nearby that location. This travel package may include just the airline reservation, just a car rental, just a hotel reservation, just a restaurant reservation, reservations for activities to do at that location, or combinations thereof.

The user may select the product through the purchase interface through any appropriate mechanism. For example, the user may touch an icon or other type of representation of the product in the menu to indicate a desire to purchase the product. In this example, the display screen 106 may include a touch interface. In other examples, the user may hover a cursor over the desired product. In yet other examples, the user may use hand gestures, speech commands, other types of commands, or combinations thereof to indicate his or her selection of a product. In some examples, the user may communicate with the purchase interface by sending a message to the purchase interface with a smart phone or other digital device.

In response to receiving the selection of the product, the purchase interface may cause at least one task associated with purchasing the product to be initiated. For example, the task may include directing the user to a website associated with the selected object. In other examples, the task may include filling out a purchase form. In yet other examples, the task may be placing the order. In some examples, the user may be prompted to provide information, such as shipping address and credit card information. In some situations, the purchase interface may already have access to this information. For example, the user may subscribe to a purchasing service associated with the purchasing interface that already has this purchasing information recorded.

The task associated with purchasing the product may occur at a remote location, such as at the cloud based device. A cloud based device may be a networked device, a device in a datacenter, a device stored at the location of the content provider, another location, or combinations thereof. In some examples, the task may be performed locally at the display device 104.

A remote device, such as the cloud based device, may send a message and/or purchase instructions to the product supplier. For example, the user may select a product from the product interface, which sends a command to the cloud based device to complete a purchase order of the product. In response to receiving this command, the cloud based device determines the supplier and completes the purchase by sending a purchase request to the supplier. In response, the supplier may ship the purchased product to the viewer's address. In some examples, a mobile device, such as a phone, tablet, laptop, and so forth, is used to facilitate communication between the cloud based device and the purchase interface. In other examples, the mobile device may communicate directly with the supplier.

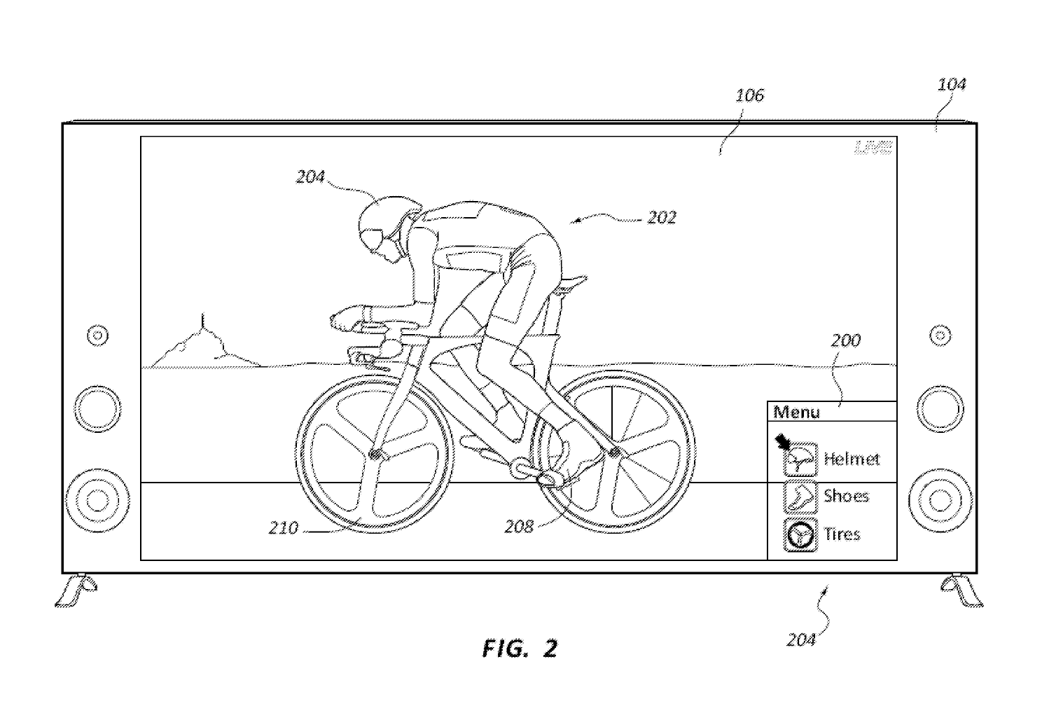

FIG. 2 depicts an example where the products are displayed in a menu 200 of the purchase interface. The display screen may be divided into multiple regions. A first region may be the purchase interface, and a second region may be dedicated to displaying dynamic content, such as a video. In some examples, no overlap exists between the first and second regions. In other examples, the first region is configured to move around within the second region and/or overlap with the second region. For example, the first region may move with the product as the product moves around on the screen. The purchase interface may include a region that displays a representation of the product. Often, the product is displayed in the dynamic content while the product is displayed in the purchase interface. But, in some examples, the product appears in the purchase interface before the product is displayed in the dynamic content and/or after the product is displayed in the dynamic content.

The first region takes up less space than the entire area of the display screen. In some examples, the first region is limited to just a corner of the display screen or just another peripheral area of the display screen. In yet other examples, the purchase interface may take up about half of the display screen. In some examples, the size of the purchase interface is adjustable so that the user can cause the purchase interface to take up as much or as little space on the display screen as desired. Further, the first region may be located in any appropriate area of the display screen, including the central area of the display screen, the peripheral area of the display screen, other areas of the display screen, or combinations thereof.

In the illustrated example, an image of a rider 202 in the cycling race is displayed in the dynamic content. At least some of the products associated with the rider 202 are represented in the menu in a bottom right corner 204 of the display screen 106 of the display device 104. In this example, rider's helmet 206, the rider's shoes 208, and the rider's wheels 210 are depicted in the menu 200.

The helmet 206, the shoes 208, and the wheels 210 may be depicted in the menu at the same time that the rider is presented in the dynamic content. In other examples, other products or fewer products depicted in the dynamic content may be displayed. For example, the user's biking shorts, shirt, watch, water bottle, socks, sunglasses, or other products associated with the cyclists may be displayed in the menu 200. In other situations, products not associated with the cyclist may be displayed in the menu. For example, race course markers, cars, guard rails, or other types of products displayed in the dynamic content may be displayed in the menu 200.

In some examples, the products associated with the rider may disappear from the menu when the rider is no longer presented in the dynamic content. In other examples, these products 206, 208, 210 may continue to be presented in the menu for a predetermined amount of time after the rider is no longer presented in the dynamic content. In other examples, the products 206, 208, 210 are continued to be displayed in the menu 200 for a time period after the rider is no longer displayed in the dynamic content, which time period is determined based on a user interaction with the purchase interface, based on a duration that the rider was presented in the dynamic content, based on preferences of the user, based on another factor, or combinations thereof.

In some examples, the user's preferences are determined to identify the products of most interest to the user. For example, in examples where the user has an account with a purchasing service, the user may input his or her likes and dislikes. In this example, those products presented in the dynamic content which are not likely to be interesting to the viewer based on the viewer's likes and dislikes may be omitted from the menu 200. On the other hand, those products which are likely to be interesting to the viewer based on the user's likes may be presented in a prominent position in the menu 200.

In another case, the display device 104 may include a camera positioned to capture images of the viewer. The camera may be in communication with program instructions that can determine, at least in part, which regions of the screen that the viewer is looking at. For example, multiple products may be displayed in the dynamic content at the same time. But, based at least in part on the images captured of the user, the system may determine that the user is looking predominately at the bottom of the screen that depicts the rider's shoes. In this example, a determination may be made that a higher likelihood exists that the viewer is interested in the shoes. In response, the shoes may be placed in a prominent position in the menu or otherwise emphasized to catch the user's attention.

In some examples, the purchase interface contains each of the products that are associated with the entire length of the dynamic content. In one situation, the user may scroll through a list of products associated with pre-recorded dynamic content, such as a movie. In this example, the user may view products during the presentation of the dynamic content that have not yet been depicted in the dynamic content. In one example where the dynamic content depicts a live streamed event, each of the products that were previously shown in the menu 200 may continue to be available in an appropriate format to allow the user to consider the option of purchasing the products after the products are no longer depicted in the display.

The user may have an option to save the products displayed in the menu 200 for review at a later date. For example, the user may enjoy watching a program without considering whether to purchase a product associated with the program. But, the user may select an option that allows the user to view those items after the program is finished. In other examples, the user may have an option of selecting products from the menu which are sent to a virtual checkout site where the user may view the items at a later time without using the display device. For example, the virtual checkout site may be accessible over the internet.

The representation of the products in the menu 200 may be an icon that resembles at least one feature of the product. In other examples, the representation may be an image of the product captured from the dynamic content. In yet other examples, the representation may include a written description, an audio file describing at least one feature of the product, a product number, a rating, a customer review of the product, other types of information, or combinations thereof.

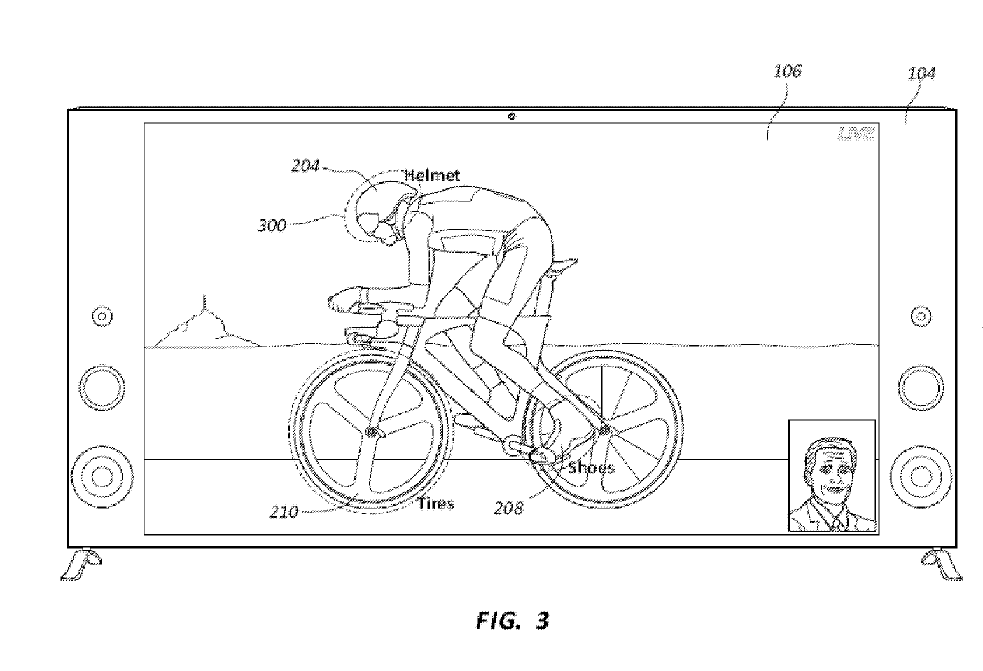

In the example of FIG. 3, the purchase interface is overlaid over various regions of the display screen 106. This purchase interface may be transparent in that the viewers can see the dynamic content through the purchase interface. In some cases, the user may not be able to even visually detect the presents of the purchase interface. This purchase interface may be also be dynamic and may include regions that map to the products in the dynamic content. From the user's perspective, this transparent, dynamic purchase interface 300 allows the user to touch the area of the display screen where the product is depicted to select a product. For example, the user may touch the helmet of the rider in the live cycling race as the helmet moves around the display screen 106. In some examples, the display may not provide an indicator that the purchase interface is active or that products depicted in the dynamic content are available for purchase. In this example, the viewer may watch the program without being distracted with the purchase interface unless the user selects or product or sends a command that causes the purchase interface or other types of indicators to be visible. But, in other examples, an indicators, such as a curser, a color, a halo, another type of indicator, or combinations thereof may be presented in the display screen proximate the products to indicate that these products are available for purchase.

The dynamic purchase interface 300 may move around the display screen as the products depicted in the dynamic content move around in the display screen. For example, as the user's helmet moves across the display screen in the dynamic content, the purchase interface moves across the display screen with the dynamic content. In some examples, the purchase interface may remain for a predetermined amount of time in an area of the screen where the product used to be. By remaining in the area after the product has left, the purchase interface may still allow a user to touch, click or otherwise interact with the purchase interface where the user expects the purchase interface to be. For example, if the image of the product disappears or moves as the user reaches out to interact with the purchase interface, the user may not touch the area where the product is currently represented in the dynamic content, but the user is still touching the area where the user expected the purchase interface to be. But, since the product used to be displayed in the area that is actually contacted by the user, the purchase interface may still remain in that area when the user interacts with that region. As a result, the purchase interface may activate even though the product has moved on and the user doesn't have to keep trying to anticipate where the purchase interface actually is.

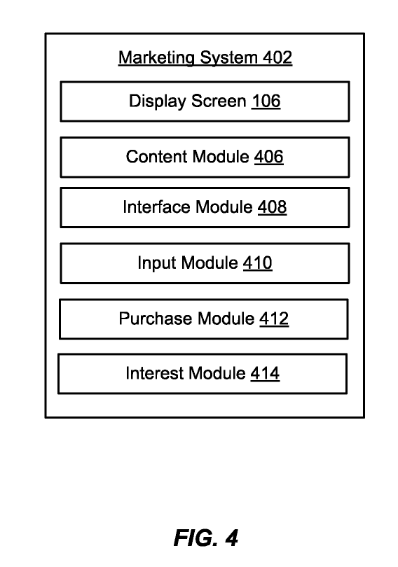

FIG. 4 illustrates a block diagram of an example of a marketing system 400 in accordance with the present disclosure. In this example, the marketing system 400 includes a display screen 106, a content module 406, an interface module 408, an input module 410, a purchase module 412, and an interest module 414. As used herein, the term “module” includes a combination of hardware and programmed instructions that are necessary for performing the designated function of the module. Components of the modules may be located on the same physical device or some of the components may be located at remote locations that are in communication with the other components of the module.

The content module 406 may include any appropriate mechanism for delivering dynamic content to the display device 104. In some examples, the dynamic content is delivered through a streaming mechanism. In some examples, the dynamic content includes a portion of a television series, a television special, a movie, a sitcom, an education program, a live event, a short video clip, another type of dynamic content, or combinations thereof.

The interface module 408 may include any appropriate mechanism for presenting to the user which products associated with the dynamic content is available for purchasing. In some examples, at least some of the products to be made available for purchase are determined before the dynamic content is delivered to the display device, such as in examples where the dynamic content is pre-recorded. In other examples, at least some of the products to make available for purchase are determined while the dynamic content is presented. In one example, the content provider may determine manually which products to make available for purchase through the interface module 408. In other examples, the interface module 408 contains mechanisms for deriving which products are presented in the dynamic content and then determining how to order the products for the user.

In some situations, the user may request that a product be made available for purchasing that was not previously identified by the interface module 408. In this situation, the user may touch a product displayed in the dynamic content for which no previously existing purchase information is available. But, an image of the selected product may be compared to other products online to determine which product is being viewed and how the user can purchase selected product. In this example, the interface module 408 determines through any appropriate mechanism the product requested by the user. The interface module 408 may make the determination through referencing repositories that contain product information about the products likely to be presented in the dynamic content. In other examples, the interface module 408 may compare the image of the product presented in the dynamic content to online resources. In other examples, the interface module 408 may send for a data request to the suppliers of related products to determine the identity of the product.

Input module 410 may include any appropriate mechanism that allows the user to indicate that the user is at least interested in a product. In some examples, the user can hover a cursor over the product, click on the product, touch the area of the screen depicting the product, use a speech command, use a gesture command, use a key board command, use a remote controller, use another type of mechanism, or combinations thereof.

The purchase module 412 may include any appropriate mechanism for initiating at least one task associated with purchasing the product. This task may include directing the user to a website with purchase instructions for the product, populating the fields of a purchase form associated with the product, completing a purchase order for the product, requesting information about the product, displaying information about the product, performing another task associated with purchasing the product, or combinations thereof.

The interest module 414 may include any appropriate mechanism for determining which products in the dynamic content is of interest to the user. In one examples, the interest module may refer to user preferences stored as part of a purchasing service. In other examples, the interest module may determine where on the screen the user to looking to determine which products that the user is viewing.

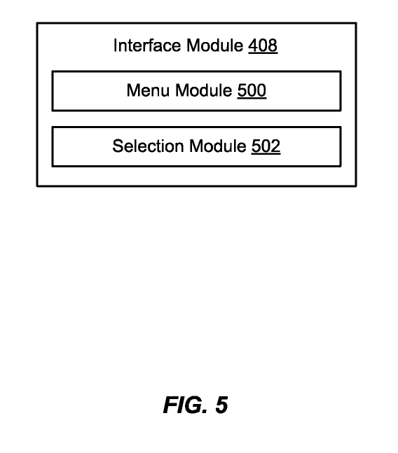

FIG. 5 illustrates a block diagram of an example of the interface module 408 in FIG. 4. In this example, the interface module 408 includes a menu module 500 and a selection module 502.

The menu module 500 may use any appropriate mechanism to create a menu of products available for purchase. This menu may include products worn by individuals depicted in the dynamic content, products used by individuals depicted in the dynamic content, playlists associated with the dynamic content, other sounds associated with the dynamic content, maps associated with the dynamic content, travel arrangements associated with the dynamic content, reservations associated with the dynamic content, services associated with the dynamic content, other types of products associated with the dynamic content, or combinations thereof.

The menu may be a customized menu that allows the user to adjust the size, font, or other parameters of the menu. In some examples, the menu may include images representative of the product, icons representative of the product, symbols representative of the product, words representative of the product, other types of indicators of the product, or combinations thereof.

The menu may include search features that allow the user to search through the various products that are currently depicted in the dynamic content, the products that were previously presented in the dynamic content, the products that will be presented in the dynamic content, products that will likely be presented in the dynamic content, products related to products displayed in the dynamic content, other types of products, or combinations thereof.

The selection module 502 may include any appropriate mechanism for selecting which products to include in the menu. These mechanisms may include collecting information about sponsors of a live event to be displayed in the dynamic content, collecting information from suppliers, analyzing user information, analyzing products of interest based on where a user to looking in the display screen, determining which products are currently displayed in the dynamic content, determining which products will at least be likely of being depicted in the dynamic content, maintaining a listing of products recently presented in the dynamic content, other mechanisms, or combinations thereof.

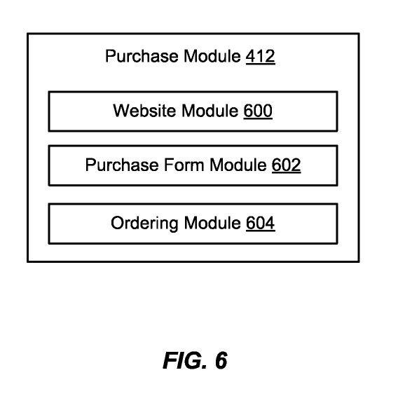

FIG. 6 illustrates a block diagram of an example of the purchase module 412 in FIG. 4. In this example, the purchase module 412 includes a website module 600, a purchase form module 602, and an ordering module 604.

The website module 600 may include any appropriate mechanism for directing the user to a website associated with the product. In some examples, this mechanism may include providing a hyperlink to a website that includes at least some information about the product. The website may include information about the product, user reviews about the product, purchasing information about the product, warranty information about the product, information about the company providing the product, other information, or combinations thereof.

The purchase form module 602 may include any appropriate mechanism for filling out a form for purchasing the product. For the purposes of this disclosure, a form may include any type of electronic field that may be used in conjunction with purchasing the product. A non-exhaustive list of examples of information that may be inputted into these fields includes billing information, shipping information, identity of purchaser, quantity of products to purchase, version of product to purchase, other types of information, or combinations thereof.

In some examples, the purchase form module 602 merely supplies the form to the user where the user can fill out the requested information. In other examples, the purchase form module 602 automatically fills information already in possession of the marketing system 400. In some cases, the purchase form module 602 may automatically fill in fields of the form based on assumptions about the user. For example, the purchase form module 602 may make an assumption that the user will desire standard shipping. This information may be based at least in part on the user's historical purchases. In other examples, these assumptions may be based at least in part on samples of data about purchasers who share common attributes with the user.

The ordering module 604 may include any appropriate mechanism for completing the purchase order. In some examples, the ordering module 604 merely sends an order request to the distributor based on the user's selection of the product in the purchase interface. In some examples, the website module 600, purchase form module 602, and ordering module 604 are used in combination while in other examples just a subset of these modules are included.

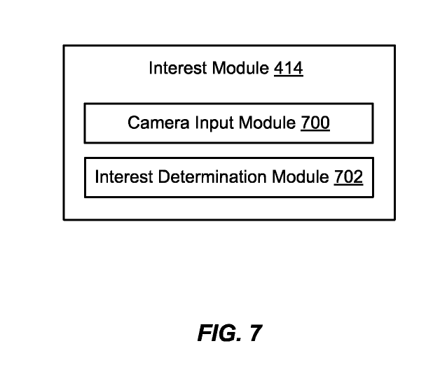

FIG. 7 illustrates a block diagram of an example of the interest module 414 in FIG. 4. In this example, the interest module 414 includes a camera input module 700 and an interest determination module 702.

The camera input module 700 may use any appropriate information from a camera input to determine at least one clue about the products interesting to the user in the dynamic content. This camera input may be gathered with a camera that is incorporated into the display device. In other examples, smart phone data, wearable glasses with computing devices, other types of wearable computing devices, location data, or combinations thereof may be used to determine at least one clue about a user's interest. For example, the camera that is part of the display device may be positioned to capture images of the user's location with respect to the display screen and also to capture where the user is looking in the display screen. This information may be correlated with the products currently being displayed in that area of the display screen.

The interest determination module 702 may include any appropriate mechanism for determining the products of interest to the user. In some examples, the camera input is used to make this determination. In other examples, user profile information, GPS location of the user's cell phone, other types of information, or combinations thereof are used to determine which products are of interest to the user and/or which products are not of interest to the user.

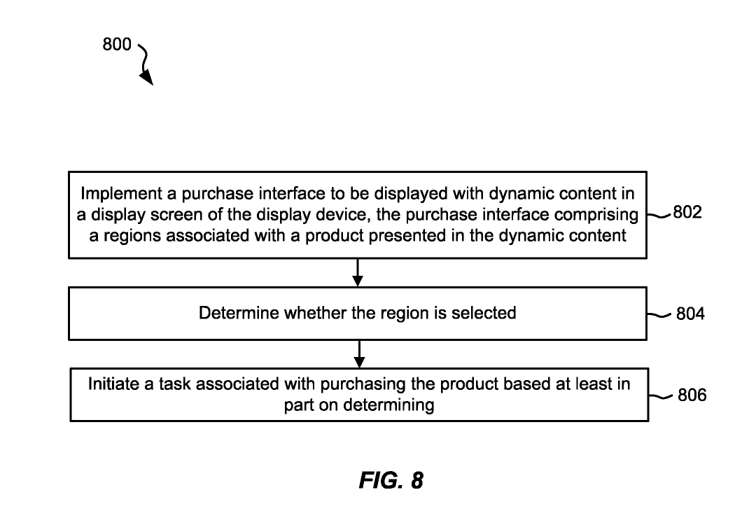

FIG. 8 is a flow diagram illustrating one embodiment of a method 800 for marketing a product. In this example, the method 800 includes implementing 802 a purchase interface to be displayed with the dynamic content in a display screen of the display device where the purchase interface has a region associated with a product presented in the dynamic content, determining 804 whether the region is selected, and initiating 806 a task associated with purchasing the product based at least in part on determining. This method 800 may be implemented with a system 100, 400 in FIGS. 1 and/or 4. In other examples, method 800 may be performed generally by the environment shown in FIG. 1.

At block 802, a purchase interface is implemented in the display screen with the dynamic content. This purchase interface may include regions of the display screen associated with a product presented in the dynamic content. The purchase interface may be sent from the dynamic content source, such as a television network, film producer, or the like. In other examples, the purchase interface is initiated by the display device. In yet other examples, the purchase interface is provided by a supplier of a product. In yet another example, the purchase interface is implemented by another party.

At block 804, whether the region of the purchase interface is selected is determined. The product selection may be determined based on whether the user selects a region of a menu, a region of a transparent dynamic purchase interface, another type of region of the purchase interface, or combinations thereof.

At block 806, a task associated with purchasing the product is initiated based at least in part on determining whether the region was selected. The task may be any appropriate task associated with purchasing the product including, but not limited to, directing the user to product information, filling out an electronic purchase form, completing an order, another type of task associated with purchasing an item, or combinations thereof.

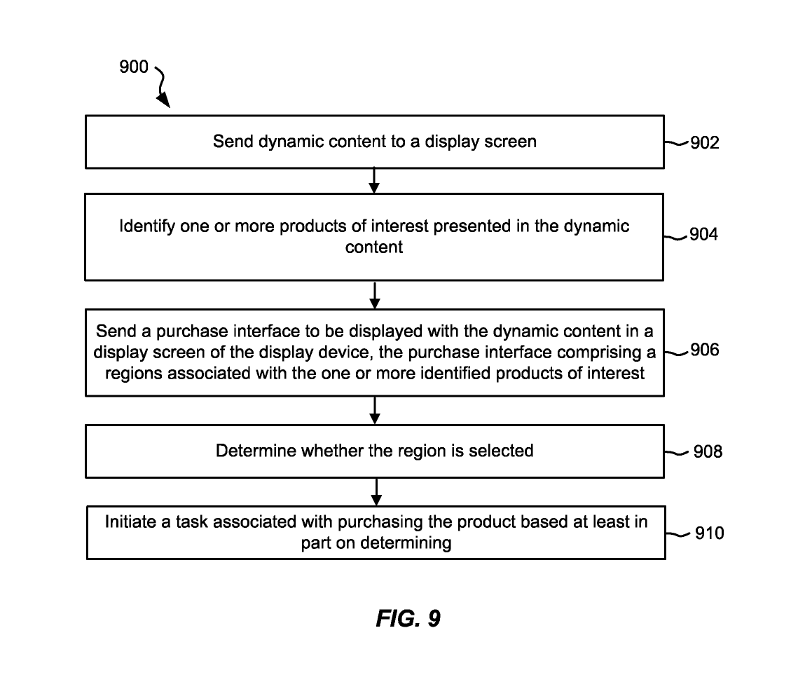

FIG. 9 is a flow diagram illustrating one embodiment of a method 900 for marketing a product. In this example, the method 900 includes sending 902 dynamic content to a display screen, identifying 904 one or more products of interest presented in the dynamic content, sending 906 a purchase interface to be displayed with the dynamic content in a display screen of the display device where the purchase interface has a region associated with a product presented in the dynamic content, determining 908 whether the region is selected, and initiating 910 a task associated with purchasing the product based at least in part on determining. This method 900 may be implemented with a system 100, 400 in FIGS. 1 and/or 4. In other examples, method 900 may be performed generally by the environment shown in FIG. 1.

At block 904, a product of interest is determined. This determination may be based, at least in part, on where the user is looking in the display screen. This information can be used to selectively display products of higher interest to the user in the menu of the purchase interface. In other examples, user preferences are analyzed from user profiles, user accounts, location data, user history, other types of mechanisms, or combinations thereof.

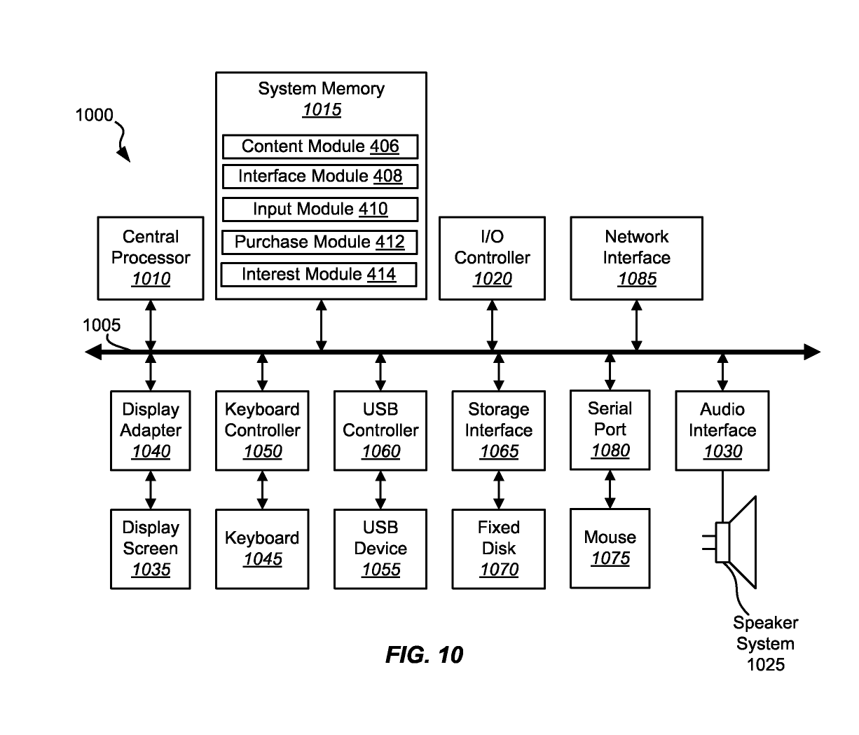

FIG. 10 depicts a block diagram of a controller 1000 suitable for implementing the present systems and methods. The controller 1000 may be an example of a controller used to operate the system 100 in FIG. 1 and/or the system in FIG. 400. In one configuration, controller 1000 includes a bus 1005 which interconnects major subsystems of controller 1000, such as a central processor 1010, a system memory 1015 (typically RAM, but which may also include ROM, flash RAM, or the like), an input/output controller 1020, an external audio device, such as a speaker system 1025 through an audio output interface 1030, an external device, such as a display screen 1035 through display adapter 1040, an input device 1045 (e.g., remote control device interfaced with an input controller 1050), multiple USB devices 1065 (interfaced with a USB controller 1070), one or more cellular radios 1090, and a storage interface 1080. Also included are at least one sensor 1055 connected to bus 1005 through a sensor controller 1060 and a network interface 1085 (coupled directly to bus 1005).

Bus 1005 allows data communication between central processor 1010 and system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a content module 406, an interface module 408, an input module 410, a purchase module 412, and an interest module 414 may be used to implement the present systems and methods may be stored within the system memory 1015. These modules may be an example of the modules illustrated in FIG. 4. Applications resident with controller 1000 are generally stored on and accessed through a non-transitory computer readable medium, such as a hard disk drive (e.g., fixed disk 1075) or other storage medium. Additionally, applications can be in the form of electronic signals modulated in accordance with the application and data communication technology when accessed through network interface 1085.

Storage interface 1080, as with the other storage interfaces of controller 1000, can connect to a standard computer readable medium for storage and/or retrieval of information, such as a fixed disk drive 1075. Fixed disk drive 1075 may be a part of controller 1000 or may be separate and accessed through other interface systems. Network interface 1085 may provide a direct connection to a remote server through a direct network link to the Internet through a POP (point of presence). Network interface 1085 may provide this connection using wireless techniques, including digital cellular telephone connection, Cellular Digital Packet Data (CDPD) connection, digital satellite data connection, or the like. In some embodiments, one or more sensors connect to controller 1000 wirelessly through network interface 1085. In one configuration, the cellular radio 1090 may include a receiver and transmitter to wirelessly receive and transmit communications through, for example, a cellular network.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 10 need not be present to practice the present systems and methods. The devices and subsystems can be interconnected in different ways from that shown in FIG. 10. The aspect of some operations of a system such as that shown in FIG. 10 are readily known in the art and are not discussed in detail in this application. Code to implement the present disclosure can be stored in a non-transitory computer-readable medium such as one or more of system memory 1015 or fixed disk 1075. The operating system provided on controller 1100 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of these directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. But, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best use the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

### INDUSTRIAL APPLICABILITY

In general, the invention disclosed herein may provide a user with way to purchase products of interest. The user saves time because the user does not have to search independently to find the product of interest nor figure out how to purchase the product. The purchase interface links the user with the same product depicted in the dynamic content and initiates at least one task for purchasing the product. For example, a user watching the Tour de France who wants to ride on the same tires as the winning cyclist can be at least directed to those tires through the purchase interface. This saves the user effort and time. Further, the user can have confidence that the tires or other products to which the user is directed are the same tires that the winner of the Tour de France uses. Thus, the user does not have to wonder whether the tires or other products found in an independent search are the same tires or products he or she desired to find. Thus, the principles described herein saves the user time and provides a greater degree of confidence that the items actually purchased are the same items that the user desired to purchase.

Further, the invention disclosed herein also provides a dynamic content provider with an additional opportunity to provide a service and thus receive an additional revenue stream. For example, the dynamic content provider may charge a fee for purchases made through the purchase interface. This fee may be a fixed fee, a percentage of the overall purchase price, another type of fee, or combinations thereof.

The invention disclosed herein also provides suppliers with an additional mechanism to market their products. A supplier of bicycle wheels may desire to have his or her tires used by competitors in live televised events so that the viewers of the event can be made aware of the supplier's tires through the purchase interface. The viewer can observe how the tires perform during the cycling race, thus helping the user make a determination about the quality of the tires or other products. Thus, the user may desire to have that particular set of tires, and the user is sparred from having to search for the same tires that he or she observes from the race.

Other suppliers, such as clothing suppliers, car distributors, service providers, etc. see opportunities to market their products in sitcoms, movies, video clips, and other types of dynamic content. In these instances, the suppliers may enter into contracts with the developers of the dynamic content to use their products in the dynamic content. Thus, the suppliers may have another mechanism for marketing their products.

The purchase interface may be any appropriate type of interface that allows the user to identify the products of interests in the dynamic content and to initiate at least one task associated with purchasing the product. The purchase interface may include a menu, a transparent dynamic mapping of the areas where the products are displayed, another mechanism to allow the user to identify and perform at least one purchasing task. The purchasing task may include directing the user to information about the product, fill in information needed to make the purchase, complete the purchase, perform another task associated with purchasing, or combinations thereof.

Implementing the purchase interface may be accomplished by the display device that has the capability to display the purchase interface and respond to the products presented in the dynamic content. In other examples, implementing the purchase interface is accomplished by sending to the display device the products to be displayed in the purchase interface. In yet other examples, implementing the purchase interface may include sending program instructions to the display device to allow the display device to present a purchase interface in the display device's display screen.

In some cases, the marketing system includes a display screen, a content module, an interface module, an input module, a purchase module, and an interest module. The content module may include any appropriate mechanism for delivering dynamic content to the display device. In some examples, the dynamic content is delivered through a streaming mechanism. In some examples, the dynamic content includes a portion of a television series, a television special, a movie, a sitcom, an education program, a live event, a short video clip, another type of dynamic content, or combinations thereof.

The interface module may include any appropriate mechanism for presenting to the user which products associated with the dynamic content is available for purchasing. In some examples, at least some of the products to be made available for purchase are determined before the dynamic content is delivered to the display device, such as in examples where the dynamic content is pre-recorded. In other examples, at least some of the products to make available for purchase are determined while the dynamic content is presented. In one example, the content provider may determine manually which products to make available for purchase through the interface module. In other examples, the interface module contains mechanisms for deriving which products are presented in the dynamic content and then determining how to order the products for the user.

In some situations, the user may request that a product be made available for purchasing that was not previously identified by the interface module. In this situation, the user may touch a product displayed in the dynamic content for which no previously existing purchase information is available. But, an image of the selected product may be compared to other products on line to determine which product is being viewed and how the user can purchase selected product. In this example, the interface module determine through any appropriate mechanism the product requested by the user. The interface module may make the determination through referencing repositories that contain product information about the products likely to be presented in the dynamic content. In other examples, the interface module may compare the image of the product presented in the dynamic content to online resources. In other examples, the interface module may send for a data request to the suppliers of related products to determine the identity of the product.

Input module may include any appropriate mechanism that allows the user to indicate that the user is at least interested in a product. In some examples, the user can hover a cursor over the product, click on the product, touch the area of the screen depicting the product, use a speech command, use a gesture command, use a key board command, use a remote controller, use another type of mechanism, or combinations thereof.

The purchase module may include any appropriate mechanism for initiating at least one task associated with purchasing the product. This task may include directing the user to a website with purchase instructions for the product, populating the fields of a purchase form associated with the product, completing a purchase order for the product, requesting information about the product, displaying information about the product, performing another task associated with purchasing the product, or combinations thereof.

The interest module may include any appropriate mechanism for determining which products in the dynamic content is of interest to the user. In one examples, the interest module may refer to user preferences stored as part of a purchasing service. In other examples, the interest module may determine where on the screen the user to looking to determine which products that the user is viewing.

The system may include the interface module with a menu module and a selection module. The menu module may use any appropriate mechanism to create a menu of products available for purchase. This menu may include products worn by individuals depicted in the dynamic content, products used by individuals depicted in the dynamic content, playlists associated with the dynamic content, other sounds associated with the dynamic content, maps associated with the dynamic content, travel arrangements associated with the dynamic content, reservations associated with the dynamic content, services associated with the dynamic content, other types of products associated with the dynamic content, or combinations thereof.

The menu may be a customized menu that allows the user to adjust the size, font, or other parameters of the menu. In some examples, the menu may include images representative of the product, icons representative of the product, symbols representative of the product, words representative of the product, other types of indicators of the product, or combinations thereof.

The menu may include search feature that allows the user to search through the various products that are currently depicted in the dynamic content, the products that were previously presented in the dynamic content, the products that will be presented in the dynamic content, products that will likely be presented in the dynamic content, products related to products displayed in the dynamic content, other types of products, or combinations thereof.

The selection module may include any appropriate mechanism for selecting which products to include in the menu. These mechanisms may include collecting information about sponsors of a live event to be displayed in the dynamic content, collecting information from suppliers, analyzing user information, analyzing products of interest based on where a user to looking in the display screen, determining which products are currently displayed in the dynamic content, determining which products will at least be likely of being depicted in the dynamic content, maintaining a listing of products recently presented in the dynamic content, other mechanisms, or combinations thereof.

In some examples, the purchase module includes a website module, a purchase form module, and an ordering module. The website module may include any appropriate mechanism for directing the user to a website associated with the product. In some examples, this mechanism may include providing a hyperlink to a website that includes at least some information about the product. The website may include information about the product, user reviews about the product, purchasing information about the product, warranty information about the product, information about the company providing the product, other information, or combinations thereof.

The purchase form module may include any appropriate mechanism for filling out a form for purchasing the product. For the purposes of this disclosure, a form may include any type of electronic field that may be used in conjunction with purchasing the product. A non-exhaustive list of examples of information that may be inputted into these fields includes billing information, shipping information, identity of purchaser, quantity of products to purchase, version of product to purchase, other types of information, or combinations thereof.

In some examples, the purchase form module merely supplies the form to the user where the user can fill out the requested information. In other examples, the purchase form module automatically fills in information already in possession of the marketing system. In some cases, the purchase form module may automatically fill in fields of the form based on assumptions about the user. For example, the purchase form module may make an assumption that the user will desire standard shipping. This information may be based at least in part on the user's historical purchases. In other examples, these assumptions may be based at least in part on samples of data about purchasers who share common attributes with the user.

The ordering module may include any appropriate mechanism for completing the purchase order. In some examples, the ordering module merely sends an order request to the distributor based on the user's selection of the product in the purchase interface. In some examples, the website module, purchase form module, and ordering module are used in combination while in other examples just a subset of these modules are included.

The interest module may include a camera input module and an interest determination module. The camera input module may use any appropriate information from a camera input to determine at least one clue about the products interesting to the user in the dynamic content. This camera input may be gathered with a camera that is incorporated into the display device. In other examples, smart phone data, wearable glasses with computing devices, other types of wearable computing devices, location data, or combinations thereof may be used to determine at least one clue about a user's interest. For example, the camera that is part of the display device may be positioned to capture images of the user's location with respect to the display screen and also to capture where the user is looking in the display screen. This information may be correlated with the products currently being displayed in that area of the display screen.

The interest determination module may include any appropriate mechanism for determining the products of interest to the user. In some examples, the camera input is used to make this determination. In other examples, user profile information, GPS location of the user's cell phone, other types of information, or combinations thereof are used to determine which products are of interest to the user and/or which products are not of interest to the user.

A method includes implementing a purchase interface to be displayed with the dynamic content in a display screen of the display device where the purchase interface has a region associated with a product presented in the dynamic content, determining whether the region is selected, and initiating a task associated with purchasing the product based at least in part on determining.

The purchase interface may include regions of the display screen associated with a product presented in the dynamic content. The purchase interface may be sent from the dynamic content source, such as a television network, film producer, or the like. In other examples, the purchase interface is initiated by the display device. In yet other examples, the purchase interface is provided by a supplier of a product. In yet another example, the purchase interface is implemented by another party.

The product selection may be determined based on whether the user selects a region of a menu, a region of a transparent dynamic purchase interface, another type of region of the purchase interface, or combinations thereof.

The task may be any appropriate task associated with purchasing the product including, but not limited to, directing the user to product information, filling out an electronic purchase form, completing an order, another type of task associated with purchasing an item, or combinations thereof.

Another method may include sending dynamic content to a display screen, identifying one or more products of interest presented in the dynamic content, sending a purchase interface to be displayed with the dynamic content in a display screen of the display device where the purchase interface has a region associated with a product presented in the dynamic content, determining whether the region is selected, and initiating a task associated with purchasing the product based at least in part on determining.

The determination may be based, at least in part, on where the user is looking in the display screen. This information can be used to selectively display products of higher interest to the user in the menu of the purchase interface. In other examples, user preferences are analyzed from user profiles, user accounts, location data, user history, other types of mechanisms, or combinations thereof.

What is claimed is:

1. A method for marketing products, comprising:
implementing a purchase interface to be displayed with dynamic content in a display screen of a display device, the purchase interface comprising a first region associated with a product presented in the dynamic content, and a second region of the display screen dedicated to displaying the dynamic content;
determining whether the first region is selected; and
initiating a task associated with purchasing the product based at least in part on the determining;
wherein the first region is a transparent dynamic area that corresponds to where the product is displayed in the display screen.

2. The method of claim 1, wherein the dynamic content depicts a real time event.

3. The method of claim 1, wherein the dynamic content is a scheduled program broadcasted over a distribution network.

4. The method of claim 1, wherein the purchase interface comprises a menu identifying the product.

5. The method of claim 1, wherein the first region moves around within the display screen with movement of the product in the display screen.

6. The method of claim 1, wherein initiating the task associated with purchasing the product comprises sending a product website that provides a mechanism for purchasing the product.

7. The method of claim 1, wherein initiating the task associated with purchasing the product comprises completing an order of the product.

8. The method of claim 1, wherein initiating the task associated with purchasing the product comprises populating user information into a digital form for purchasing the product.

9. The method of claim 1, wherein sending dynamic content to the display screen comprises streaming the dynamic content to the display screen.

10. The method of claim 1, wherein the product comprises at least one of an article of clothing visually depicted in the dynamic content, an apparatus visually depicted in the dynamic content, or combinations thereof.

11. The method of claim 1, wherein the product comprises an audio component of the dynamic content presented with a visual component of the dynamic content.

12. The method of claim 1, wherein the product comprises a map of a route displayed in the dynamic content.

13. The method of claim 1, further comprising identifying one or more products of interest presented in the dynamic content based at least in part on an area of the display device being viewed.

14. The method of claim 13, wherein identifying one or more products of interest comprises capturing, with a camera, an image of a user viewing the display screen.

15. The method of claim 13, further comprising depicting the one or more products of interest in a menu presented in the display screen.

16. A system for marketing products, comprising:
a content module to send dynamic content to a display device;
an interface module to send a purchase interface to be displayed with the dynamic content in a display screen of the display device, the purchase interface comprising a region associated with a product presented in the dynamic content;
an input module to determine whether the region is selected;
a purchase module to initiate a task associated with purchasing the product in response to the determining;
an interest module to identify one or more products of interest presented in the dynamic content based at least in part on an area of the display device being viewed; and
a menu module to depict products of interest in a menu presented in the display screen.

17. The system of claim 16, wherein the product comprises at least one of an article of clothing visually depicted in the dynamic content, an apparatus visually depicted in the dynamic content, or combinations thereof.

18. The system of claim 16, wherein the product comprises an audio component of the dynamic content presented with a visual component of the dynamic content.

19. The system of claim 17, wherein the product comprises a map of a route displayed in the dynamic content.

20. A display device, comprising:
a display screen to depict dynamic content;
a processor and memory, the memory comprising programmed instructions to cause the processor to:
present a purchase interface with the dynamic content in the display screen, the purchase interface comprising a region associated with a product presented in the dynamic content;
determine whether the region is selected; and
initiate a task associated with purchasing the product in response to the determining.
